(19) United States
(12) Patent Application Publication
(10) Pub. No.: US 2002/0164910 A1
(43) Pub. Date: Nov. 7, 2002

(54) Wipes

(76) Inventor: Simon John Murray, Crawley (GB)

Correspondence Address: Edwin D. Schindler, Five Hirsch Avenue, P.O. Box 966, Coram, NY, 11727-0966, US

(21) Appl. No.: 10/120,263

(22) Filed: Apr. 9, 2002

(30) Foreign Application Priority Data
Apr. 9, 2001 (GB) 0108777.4

(51) Int. Cl. B32B 27/04; B32B 3/00; B32B 5/02; B32B 27/12; B32B 9/00

(52) U.S. Cl. 442/96; 442/59; 428/905

(57) ABSTRACT

A wipe comprises a piece of sheet material impregnated with a solution rendering the wipe effective in cleaning the fingers or face of an infant or young child, the solution having an attractive flavor, preferably a flavor characteristic of a natural fruit or combination of natural fruits.

### BACKGROUND OF THE INVENTION

The present invention relates to wipes which are used for wiping clean the fingers or face, particularly, of an infant or young child.

Such wipes are in common usage nowadays, and comprise a piece of sheet material which is impregnated with a solution which makes the wipe effective in wiping clean the fingers or face etc. of an infant or young child. Often, however, the infant or young child resists having his or her face wipe by such wipes.

### SUMMARY OF THE INVENTION

I have now devised a wipe which alleviates the above difficulty, in providing an attraction to the child when the wipe is used.

In accordance with the present invention, there is provided a wipe which comprises a piece of sheet material which is impregnated with a solution rendering the wipe effective in wiping clean the fingers or face of an infant or young child, the solution having an attractive flavour.

Preferably the flavour of the impregnating solution comprises a flavour characteristic of a natural fruit, or characteristic of the combination of two or more natural fruits.

Preferably the wipe is printed or otherwise marked with one or more visual representations of the fruit or fruits of which the flavour of the impregnating solution of the wipe is characteristic.

Preferably a number of flavoured wipes, in accordance with the present invention, are housed within a container, the outer surface of which is also printed or otherwise marked with a visual representation of the fruit or fruits of which the flavour of the wipe is characteristic.

### BRIEF DESCRIPTION OF THE DRAWINGS

An embodiment of the present invention will now be described by way of example only and with reference to the accompanying drawings, in which:

FIG. 1 is a view of a wipe in accordance with the present invention; and

FIG. 2 is a view of a dispenser of such wipes.

### DETAILED DESCRIPTION OF THE PREFERRED EMBODIMENTS

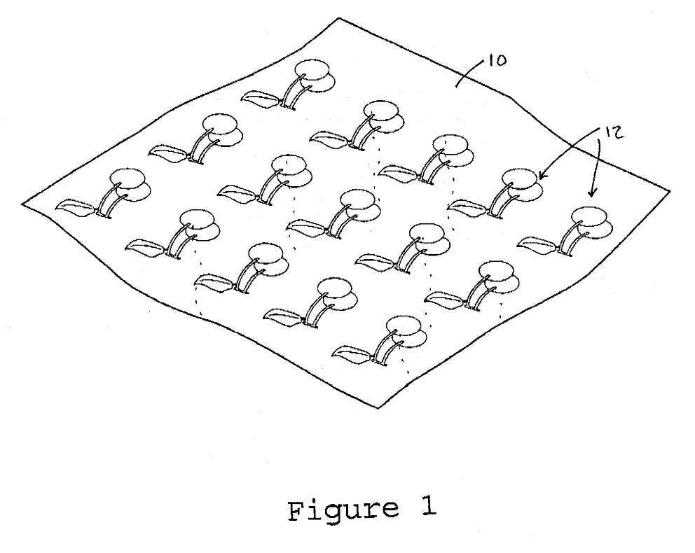

Referring to FIG. 1, there is shown a wipe 10 which comprises a generally rectangular piece of flexible sheet material, impregnated with a solution enabling the wipe to be effective in wiping clean the fingers or face etc., particularly of infants or young children.

In accordance with the present invention, the solution, with which the wipe is impregnated, has an attractive flavour; in the example shown, this is a cherry flavour. Furthermore, the wipe 10 is printed or otherwise marked with an array of representations 12 of cherries, corresponding to the flavour of the solution with which the wipe is impregnated.

Typically, the wipe 10 comprises a cellulose-fibre based sheet material, and the impregnating solution comprises a cleaning solution to which an artificial flavouring has been added.

Because the impregnating solution of the wipe is of an attractive flavour, the wipe is considerably more acceptable to a child when used to wipe the child's face in particular. Where the flavour is of a fruit, this may indeed help to familiarise the child with the flavour of the natural fruit itself and so encourage the child to eat the fruit and develop a healthier diet.

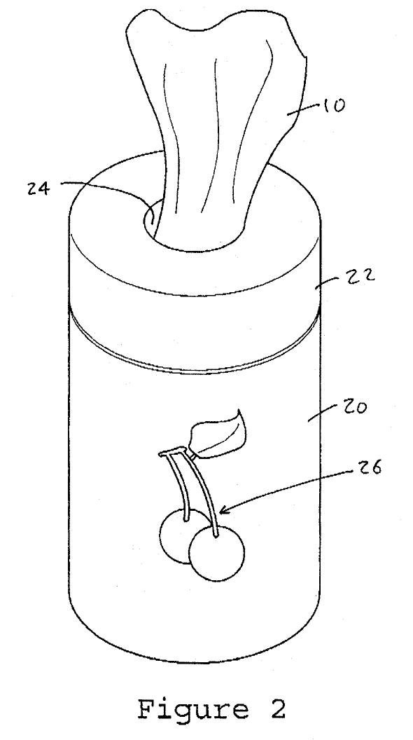

Referring to FIG. 2, there is shown a container of wipes, the container being in the form of a cylindrical drum 20 housing a lid 22 provided with a central aperture 24.

A roll of wipes (each as shown in FIG. 1) is housed within the container and the wipes e.g. 10 can be withdrawn one-at-a-time through the aperture 24 in the lid 22. The outside surface of the container is printed or otherwise marked with a representation 26 of cherries, corresponding to the fruit the flavour of which is carried by the wipes housed in the container.

1) A wipe which comprises a piece of sheet material which is impregnated with a solution rendering the wipe effective in wiping clean the fingers or face of an infant or young child, the solution having an attractive flavour.

2) A wipe as claimed in claim 1, in which the flavour of the impregnating solution comprises a flavour characteristic of a natural fruit.

3) A wipe as claimed in claim 2, in which said piece of material is marked with at least one visual representation of the fruit of which the flavour of the impregnating solution is characteristic.

4) A wipe as claimed in claim 1, in which the flavour of the impregnating solution comprises a flavour characteristic of the combination of at least two natural fruits.

5) A wipe as claimed in claim 4, in which said piece of material is marked with at least one visual representation of the fruits of which the flavour of the impregnating solution is characteristics.

6) A container and a plurality of wipes housed within said container, each said wipe comprising a piece of sheet material which is impregnated with a solution rendering the wipe effective in wiping clean the fingers or face of an infant or young child, the solution having a flavour characteristic of a natural fruit or the combination of at least two natural fruits, and the container having an outer surface marked with a visual representation of the fruit or fruits of which the flavour of the impregnating solution is characteristic.
